(19) United States
(12) Patent Application Publication
(10) Pub. No.: US 2019/0238843 A1
(43) Pub. Date: Aug. 1, 2019

(54) DEVICES AND METHODS FOR VIDEO CODING

(71) Applicant: Huawei Technologies Co., Ltd., Shenzhen (CN)

(72) Inventors: Alexey Konstantinovich FILIPPOV, Moscow (RU); Vasily Alexeevich RUFITSKIY, Moscow (RU)

(21) Appl. No.: 16/383,256

(22) Filed: Apr. 12, 2019

Related U.S. Application Data
(63) Continuation of application No. PCT/RU2016/000704, filed on Oct. 14, 2016.

(51) Int. Cl. H04N 19/11; H04N 19/107; H04N 19/593; H04N 19/503; H04N 19/467

(52) U.S. Cl. CPC H04N 19/11; H04N 19/107; H04N 19/467; H04N 19/503; H04N 19/593

(57) ABSTRACT

A frame of encoded video data is partitioned into a plurality of video coding blocks, including a current video coding block, the current video coding block comprising a plurality of sub-blocks. The encoded video data is decoded to provide a residual video coding block associated with the current video coding block. Parameter adjustment information is extracted from the encoded video data. A predicted video coding block is generated by generating for each sub-block of the current video coding block a predicted sub-block. A prediction parameter is defined for the current video coding block on the basis of the parameter adjustment information and the predicted sub-block is generated on the basis of the adjusted prediction parameter. The current video coding block is restored on the basis of the residual video coding block and the predicted video coding block.

### CROSS-REFERENCE TO RELATED APPLICATIONS

This application is a continuation of International Application No. PCT/RU2016/000704, filed on Oct. 14, 2016, which is hereby incorporated by reference in its entirety.

### TECHNICAL FIELD

The present disclosure relates to the field of video coding. More specifically, the disclosure relates to an encoding apparatus and a decoding apparatus for coding video data.

### BACKGROUND

Digital video communication and storage applications are implemented by a wide range of digital devices, e.g. digital cameras, cellular radio telephones, laptops, broadcasting systems, video teleconferencing systems, etc. One of the most important and challenging tasks of these applications is video compression. The task of video compression is complex and is constrained by two contradicting parameters: compression efficiency and computational complexity. Video coding standards, such as ITU-T H.264/AVC or ITU-T H.265/HEVC, provide a good tradeoff between these parameters. For that reason support of video coding standards is a mandatory requirement for almost any video compression application.

The state-of-the-art video coding standards are based on partitioning of a source picture into video coding blocks (or short blocks). Processing of these blocks depend on their size, spatial position and a coding mode specified by an encoder. Coding modes can be classified into two groups according to the type of prediction: intra- and inter-prediction modes. Intra-prediction modes use pixels of the same picture (also referred to as frame or image) to generate reference samples to calculate the prediction values for the pixels of the block being reconstructed. Intra-prediction is also referred to as spatial prediction. Inter-prediction modes are designed for temporal prediction and uses reference samples of previous or next pictures to predict pixels of the block of the current picture. After a prediction stage, transform coding is performed for a prediction error that is the difference between an original signal and its prediction. Then, the transform coefficients and side information are encoded using an entropy coder (e.g., CABAC for AVC/H.264 and HEVC/H.265). The recently adopted ITU-T H.265/HEVC standard (ISO/IEC 23008-2:2013, “Information technology—High efficiency coding and media delivery in heterogeneous environments—Part 2: High efficiency video coding”, November 2013) declares a set of state-of-the-art video coding tools that provide a reasonable tradeoff between coding efficiency and computational complexity. An overview on the ITU-T H.265/HEVC standard has been given by Gary J. Sullivan, “Overview of the High Efficiency Video Coding (HEVC) Standard”, in IEEE Transactions on Circuits and Systems for Video Technology, Vol. 22, No. 12, December 2012, the entire content of which is incorporated herein by reference.

Similarly to the ITU-T H.264/AVC video coding standard, the HEVC/H.265 video coding standard provides for a division of the source picture into blocks, e.g., coding units (CUs). Each of the CUs can be further split into either smaller CUs or prediction units (PUs). A PU can be intra- or inter-predicted according to the type of processing applied for the pixels of PU. In case of inter-prediction, a PU represents an area of pixels that is processed by motion compensation using a motion vector specified for a PU. For intra prediction, the adjacent pixels of neighbor blocks are used as reference samples to predict a current block. A PU specifies a prediction mode that is selected from the set of intra-prediction modes for all the transform units (TUs) contained in this PU. A TU can have different sizes (e.g., 4×4, 8×8, 16×16 and 32×32 pixels) and can be processed in different ways. For a TU, transform coding is performed, i.e. the prediction error is transformed with a discrete cosine transform or a discrete sine transform (in the HEVC/H.265 standard, it is applied to intra-coded blocks) and quantized. Hence, reconstructed pixels contain quantization noise (it can become apparent, for examples, as blockiness between units, ringing artifacts along with sharp edges, etc.) that in-loop filters such as DBF, SAO and ALF try to suppress. The use of sophisticated prediction coding (such as motion compensation and intra-prediction) and partitioning techniques (e.g., QT for CUs and PUs as well as RQT for TUs) allowed the standardization committee to significantly reduce the redundancy in PUs.

The prediction tools which led to the prosperous application of these video coding standards can be roughly distinguished into inter and intra prediction tools. While intra prediction solely relies on information which is contained in the current picture, inter prediction employs the redundancy between different pictures to further increase the coding efficiency. Therefore, in general intra prediction requires higher bitrates than inter prediction to achieve the same visual quality for typical video signals.

Currently, different mechanisms are used to signal the information on what of the predictors that can be generated by either an intra- or inter-prediction tool should be selected. The most straightforward way is to use one of more bits on the coding unit (CU) or prediction unit (PU) levels, at which the intra-prediction mode is signaled. This approach was implemented for numerous tools (e.g., PDPC and MPI). Another mechanism was implemented for Enhanced Multiple Transform (EMT) also known as Adaptive Multiple Transform (AMT). The basic idea behind this approach is to use a CU level flag (emtCuFlag) that signals whether a TU level index (emtTuIdx) is needed or not. However, EMT does not directly relate to the prediction coding part.

Another aspect of signaling is how this information can be encoded and decoded. In the case of using a conventional approach, this information is entropy coded. For instance, CABAC or other entropy coders can be used. Another approach is to hide the side information either in residues or in prediction information. In the latter approach, a check function is applied to the host signal (i.e. to either residues or magnitudes of motion vector difference projections) to retrieve a hidden value at the decoder side. Thus, there are different ways how to signal a selected prediction mode. However, they are disintegrated and not tuned to work with each other.

The main problem is that non-systematized signaling mechanisms of prediction tools cause significant overhead in different hybrid video coding frameworks such as HM and JEM. If any combination of prediction-related syntax elements is enabled, another consequence of this problem can be the increase of the computational complexity at the encoder side as the number of encoder-side passes is increased.

Thus, there is a need for devices and methods for video coding.

### SUMMARY

It is an object to provide devices and methods for video coding.

The foregoing and other objects are achieved by the subject matter of the independent claims. Further implementation forms are apparent from the dependent claims, the description and the figures.

The following disclosure employs a plurality of terms which, in embodiments, have the following meaning: Slice—a spatially distinct region of a picture that is independently encoded/decoded. Slice header—Data structure configured to signal information associated with a particular slice. Video coding block (or short block)—an M×N (M-column by N-row) array of pixels or samples (each pixel/sample being associated with at least one pixel/sample value), or an M×N array of transform coefficients. Coding Tree Unit (CTU) grid—a grid structure employed to partition blocks of pixels into macro-blocks for video encoding. Coding Unit (CU)—a coding block of luma samples, two corresponding coding blocks of chroma samples of an image that has three sample arrays, or a coding block of samples of a monochrome picture or a picture that is coded using three separate color planes and syntax used to code the samples. Picture Parameter Set (PPS)—a syntax structure containing syntax elements that apply to zero or more entire coded pictures as determined by a syntax element found in each slice segment header. Sequence Parameter Set (SPS)—a syntax structure containing syntax elements that apply to zero or more entire coded video sequences as determined by the content of a syntax element found in the PPS referred to by a syntax element found in each slice segment header. Video Parameter Set (VPS)—a syntax structure containing syntax elements that apply to zero or more entire coded video sequences. Prediction Unit (PU)—a prediction block of luma samples, two corresponding prediction blocks of chroma samples of a picture that has three sample arrays, or a prediction block of samples of a monochrome picture or a picture that is coded using three separate color planes and syntax used to predict the prediction block samples. Transform Unit (TU)—a transform block of luma samples, two corresponding transform blocks of chroma samples of a picture that has three sample arrays, or a transform block of samples of a monochrome picture or a picture that is coded using three separate color planes and syntax used to predict the transform block samples. Supplemental enhancement information (SEI)—extra information that may be inserted into a video bit-stream to enhance the use of the video. Luma—information indicating the brightness of an image sample. Chroma—information indicating the color of an image sample, which may be described in terms of red difference chroma component (Cr) and blue difference chroma component (Cb).

According to a first aspect the disclosure relates to an apparatus for decoding encoded video data, the encoded video data comprising a plurality of frames, each frame being partitioned into a plurality of video coding blocks, including a current, i.e. currently processed, video coding block, the current video coding block comprising a plurality of sub-blocks of a lower hierarchical level than the current video coding block. The apparatus comprises: a decoding unit configured to decode the encoded video data for providing a residual video coding block associated with the current video coding block and to extract parameter adjustment information from the encoded video data; a prediction unit configured to generate for the current video coding block a predicted video coding block by generating for each sub-block of the current video coding block a predicted sub-block, wherein the prediction unit is further configured to adjust for each sub-block of the current video coding block a prediction parameter defined for the current video coding block on the basis of the parameter adjustment information and to generate the predicted sub-block on the basis of the adjusted prediction parameter; and a restoration unit (also referred to as transform unit) configured to restore the current video coding block on the basis of the residual video coding block and the predicted video coding block.

In an implementation form the current video coding block can be a CU consisting of sub-blocks in the form of PUs and/or TUs. Alternatively, the current video coding block can be a PU consisting of sub-blocks in the form of TUs.

In a first possible implementation form of the decoding apparatus according to the first aspect as such, the prediction unit is configured to perform an intra prediction and/or an inter prediction for generating the predicted video coding block.

In a second possible implementation form of the decoding apparatus according to the first aspect as such or the first implementation form thereof, the encoded video data is entropy encoded and the decoding unit is configured to extract the parameter adjustment information from the encoded video data by decoding the encoded video data.

In a third possible implementation form of the decoding apparatus according to the first aspect as such or the first implementation form thereof, the parameter adjustment information is hidden in the encoded video data and the decoding unit is configured to extract the parameter adjustment information from the encoded video data by applying a check function, in particular a parity check function, to at least a portion of the encoded video data.

In a fourth possible implementation form of the decoding apparatus according to the first aspect as such or any one of the first to third implementation form thereof, the prediction parameter is a prediction flag defining a first prediction flag state and a second prediction flag state and the prediction unit is configured to adjust the state of the prediction flag on the basis of the parameter adjustment information.

In a fifth possible implementation form of the decoding apparatus according to the fourth implementation form of the first aspect, the prediction parameter defines an intra-prediction mode, e.g. the prediction parameter is an intra-prediction mode index.

According to a second aspect the disclosure relates of a method for decoding encoded video data, the encoded video data comprising a plurality of frames, each frame being partitioned into a plurality of video coding blocks, including a current, i.e. currently processed, video coding block, the current video coding block comprising a plurality of sub-blocks of a lower hierarchical level than the current video coding block. The decoding method comprises: decoding the encoded video data for providing a residual video coding block associated with the current video coding block and extracting parameter adjustment information from the encoded video data; generating for the current video coding block a predicted video coding block by generating for each sub-block of the current video coding block a predicted sub-block, including the steps of adjusting for each sub-block of the current video coding block a prediction parameter defined for the current video coding block on the basis of the parameter adjustment information and generating the predicted sub-block on the basis of the adjusted prediction parameter; and restoring the current video coding block on the basis of the residual video coding block and the predicted video coding block.

The decoding method according to the second aspect of the disclosure can be performed by the decoding apparatus according to the first aspect of the disclosure. Further features of the decoding method according to the second aspect of the disclosure result directly from the functionality of the decoding apparatus according to the first aspect of the disclosure and its different implementation forms.

According to a third aspect the disclosure relates to an apparatus for encoding video data, the encoded video data comprising a plurality of frames, each frame being dividable into a plurality of video coding blocks, including a current, i.e. currently processed, video coding block, the current video coding block comprising a plurality of sub-blocks of a lower hierarchical level than the current video coding block. The encoding apparatus comprises: a prediction unit configured to generate for the current video coding block a predicted video coding block on the basis of a prediction parameter by generating for each sub-block of the current video coding block a predicted sub-block, wherein the prediction unit is further configured to generate parameter adjustment information for each sub-block of the current video coding block, for which the predicted sub-block is generated on the basis of an adjusted prediction parameter instead of the prediction parameter; and an encoding unit configured to generate encoded video data, wherein the encoded video data contains an encoded video coding block based on the predicted video coding block and wherein the encoded video data contains the parameter adjustment information.

In an implementation form the current video coding block can be a CU consisting of sub-blocks in the form of PUs and/or TUs. Alternatively, the current video coding block can be a PU consisting of sub-blocks in the form of TUs.

In a first possible implementation form of the encoding apparatus according to the second aspect as such, the prediction unit is configured to perform an intra prediction and/or an inter prediction for generating the predicted video coding block on the basis of the current video coding block.

In a second possible implementation form of the encoding apparatus according to the second aspect as such or the first implementation form thereof, the prediction unit is further configured to decide for each sub-block of the current video coding block on the basis of a rate distortion criterion whether to generate the predicted sub-block on the basis of an adjusted prediction parameter instead of the prediction parameter.

In a third possible implementation form of the encoding apparatus according to the second aspect as such or the first or second implementation form thereof, the encoding unit is configured to include the parameter adjustment information as entropy encoded parameter adjustment information in the encoded video data.

In a fourth possible implementation form of the encoding apparatus according to the second aspect as such or the first or second implementation form thereof, the encoding unit is configured to include the parameter adjustment information in the encoded video data on the basis of a data hiding technique.

In a fifth possible implementation form of the encoding apparatus according to the second aspect as such or the first or second implementation form thereof, the encoding unit is configured to include the parameter adjustment information in the encoded video data on the basis of a data hiding technique or to include the parameter adjustment information as entropy encoded parameter adjustment information in the encoded video data depending on the value of a redundancy measure associated with a difference between the current video coding block and the predicted video coding block.

If the redundancy, which is sufficient for performing data hiding, is detected in the prediction-related syntax elements, a prediction parameter to be coded at the same hierarchical level should be hidden within them. Otherwise, entropy coding is used for signaling. A similar approach is applied to data hiding in the residues: if the redundancy is detected there, data hiding should be used. Otherwise, entropy coding is used for signaling at the TU level.

According to a fourth aspect the disclosure relates to a method for encoding video data, the encoded video data comprising a plurality of frames, each frame being dividable into a plurality of video coding blocks, including a current, i.e. currently processed, video coding block, the current video coding block comprising a plurality of sub-blocks of a lower hierarchical level than the current video coding block. The encoding method comprises: generating for the current video coding block a predicted video coding block on the basis of a prediction parameter by generating for each sub-block of the current video coding block a predicted sub-block, including the step of generating parameter adjustment information for each sub-block of the current video coding block, for which the predicted sub-block is generated on the basis of an adjusted prediction parameter instead of the prediction parameter; and generating encoded video data, wherein the encoded video data contains an encoded video coding block based on the predicted video coding block and wherein the encoded video data contains the parameter adjustment information.

The encoding method according to the fourth aspect of the disclosure can be performed by the encoding apparatus according to the third aspect of the disclosure. Further features of the encoding method according to the fourth aspect of the disclosure result directly from the functionality of the encoding apparatus according to the third aspect of the disclosure and its different implementation forms.

According to a fifth aspect the disclosure relates to a computer program comprising program code for performing the method according to the fourth aspect when executed on a computer.

Embodiments of the disclosure allow improving signaling mechanisms used in the HM and JEM frameworks to indicate a selected predictor. Embodiments of the disclosure provide a hierarchically structured signaling mechanism that enables adjusting a prediction parameter selected on higher hierarchical level by signaling additional information, i.e. parameter adjustment information, on lower hierarchical levels. Moreover, embodiments of the disclosure allow adaptively selecting between entropy coding and data hiding to indicate a selected prediction parameter.

The embodiments can be implemented in hardware and/or software.

### BRIEF DESCRIPTION OF THE DRAWINGS

Further embodiments will be described with respect to the following figures, wherein:

FIG. 1 shows a schematic diagram illustrating an encoding apparatus according to an embodiment and a decoding apparatus according to an embodiment;

FIG. 2 shows a schematic diagram illustrating a decoding method according to an embodiment;

FIG. 3 shows a schematic diagram illustrating an encoding method according to an embodiment;

FIG. 4 shows a schematic diagram of an exemplary video coding block illustrating aspects implemented in embodiments of the disclosure;

FIG. 5 shows a diagram providing an overview of prediction parameters that can be used by embodiments of the disclosure;

FIG. 6 shows a diagram illustrating processing steps implemented in a decoding apparatus according to an embodiment;

FIGS. 7a and 7b show diagrams illustrating processing steps implemented in decoding apparatuses according to different embodiments;

FIG. 8 shows a diagram illustrating processing steps implemented in an encoding apparatus according to an embodiment;

FIGS. 9a and 9b show diagrams illustrating processing steps implemented in an encoding apparatus according to an embodiment;

FIGS. 10a and 10b show diagrams illustrating processing steps implemented in an decoding apparatus according to an embodiment;

FIG. 11 shows three different video coding blocks predicted by different embodiments of the disclosure;

FIG. 12 shows a diagram illustrating processing steps implemented in an encoding apparatus according to an embodiment;

FIG. 13 shows a diagram illustrating processing steps implemented in a decoding apparatus according to an embodiment;

FIG. 14 shows a diagram illustrating processing steps implemented in a decoding apparatus according to an embodiment;

FIG. 15 shows a diagram illustrating processing steps implemented in a decoding apparatus according to an embodiment; and

FIG. 16 shows a schematic diagram of an exemplary video coding block illustrating aspects implemented in embodiments of the disclosure.

In the various figures, identical reference signs will be used for identical or at least functionally equivalent features.

### DETAILED DESCRIPTION OF EMBODIMENTS

In the following description, reference is made to the accompanying drawings, which form part of the disclosure, and in which are shown, by way of illustration, specific aspects in which the present disclosure may be placed. It is understood that other aspects may be utilized and structural or logical changes may be made without departing from the scope of the present disclosure. The following detailed description, therefore, is not to be taken in a limiting sense, as the scope of the present disclosure is defined be the appended claims.

For instance, it is understood that a disclosure in connection with a described method may also hold true for a corresponding device or system configured to perform the method and vice versa. For example, if a specific method step is described, a corresponding device may include a unit to perform the described method step, even if such unit is not explicitly described or illustrated in the figures. Further, it is understood that the features of the various exemplary aspects described herein may be combined with each other, unless specifically noted otherwise.

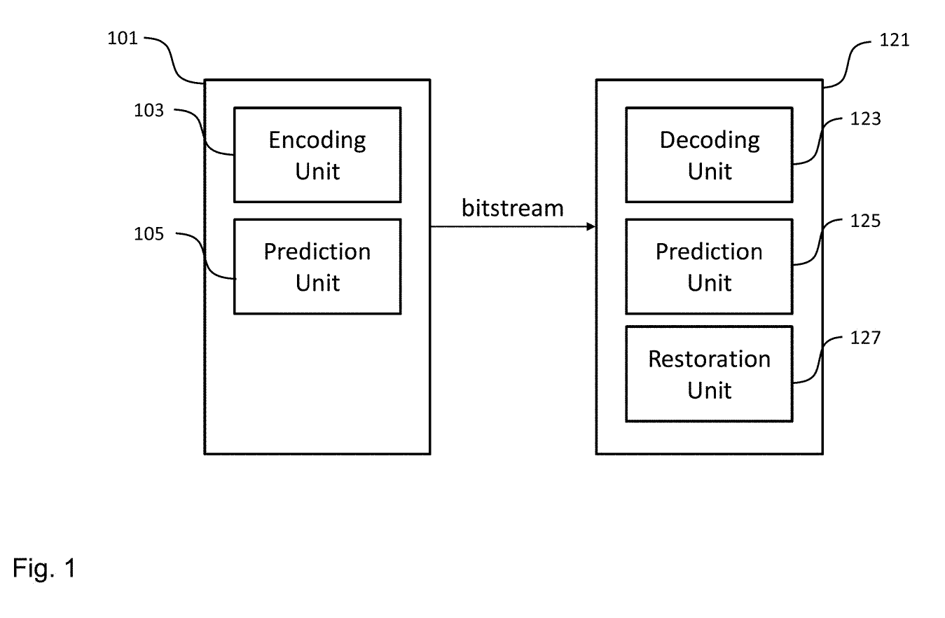

FIG. 1 shows a schematic diagram illustrating an encoding apparatus 101 for encoding video data according to an embodiment and a decoding apparatus 121 for decoding video data according to an embodiment.

The encoding apparatus 101 is configured to encode video data, wherein the encoded video data comprises a plurality of frames, each frame is dividable into a plurality of video coding blocks, including a current, i.e. currently processed, video coding block, and the current video coding block comprises a plurality of sub-blocks of a lower hierarchical level than the current video coding block.

In an embodiment, the current video coding block can be a CU consisting of sub-blocks in the form of PUs and/or TUs. Alternatively, the current video coding block can be a PU consisting of sub-blocks in the form of TUs.

The encoding apparatus 101 comprises a prediction unit 105 configured to generate for the current video coding block a predicted video coding block on the basis of at least one prediction parameter by generating for each sub-block of the current video coding block a predicted sub-block, wherein the prediction unit 105 is further configured to generate parameter adjustment information for each sub-block of the current video coding block, for which the predicted sub-block is generated on the basis of an adjusted prediction parameter instead of the prediction parameter.

Furthermore, the encoding apparatus 101 comprises an encoding unit 103 configured to generate encoded video data, wherein the encoded video data contains an encoded video coding block based on the predicted video coding block and the parameter adjustment information.

In an embodiment, the encoding apparatus 101 could be implemented as a hybrid encoder, as defined, for instance, in the HEVC standard, and could comprise further components not shown in FIG. 1, such as an entropy encoder.

The decoding apparatus 121 is configured to decode the encoded video data provided by the encoding apparatus 101, for instance, in the form of a bitstream.

The decoding apparatus 121 comprises a decoding unit 123 configured to decode the encoded video data for providing a residual video coding block associated with the current video coding block and to extract parameter adjustment information from the encoded video data.

Moreover, the decoding apparatus 121 comprises a prediction unit 125 configured to generate for the current video coding block a predicted video coding block by generating for each sub-block of the current video coding block a predicted sub-block, wherein the prediction unit 125 is further configured to adjust for each sub-block of the current video coding block a prediction parameter defined for the current video coding block on the basis of the parameter adjustment information and to generate the predicted sub-block on the basis of the adjusted prediction parameter.

Moreover, the decoding apparatus 121 comprises a restoration unit 127 (sometimes also referred to as transform unit) configured to restore the current video coding block on the basis of the residual video coding block and the predicted video coding block.

In an embodiment, the decoding apparatus 121 could be implemented as a hybrid decoder, as defined, for instance, in the HEVC standard, and could comprise further components not shown in FIG. 1.

In an embodiment, the prediction unit 105 of the encoding apparatus 101 and the prediction unit 125 of the decoding apparatus 121 are configured to perform an intra prediction and/or an inter prediction for generating the predicted video coding block.

In an embodiment, the prediction unit 105 of the encoding apparatus 101 is further configured to decide for each sub-block of the current video coding block on the basis of a rate distortion criterion whether to generate the predicted sub-block on the basis of an adjusted prediction parameter.

In an embodiment, the encoding unit 103 of the encoding apparatus 101 is configured to include the parameter adjustment information as entropy encoded parameter adjustment information in the encoded video data. For such an embodiment, the decoding unit 123 of the decoding apparatus 121 is configured to extract the parameter adjustment information from the encoded video data by decoding the encoded video data.

In an embodiment, the encoding unit 103 of the encoding apparatus 101 is configured to include the parameter adjustment information in the encoded video data on the basis of a data hiding technique. For such an embodiment the decoding unit 123 of the decoding apparatus can be configured to extract the parameter adjustment information from the encoded video data by applying a check function, in particular a parity check function, to at least a portion of the encoded video data containing the hidden parameter adjustment information.

More details about data hiding techniques, which can be implemented in embodiments of the disclosure for hiding the parameter adjustment information in the encoded video data, can be found, for instance, Vivienne Sze, Madhukar Budagavi, Gary J. Sullivan, “High Efficiency Video Coding (HEVC): Algorithms and Architectures,” Springer, 2014, ISBN 978-3-319-06895-4, which is fully incorporated herein by reference.

In an embodiment, the encoding unit 103 of the encoding apparatus 101 is configured to include the parameter adjustment information in the encoded video data on the basis of a data hiding technique or to include the parameter adjustment information as entropy encoded parameter adjustment information in the encoded video data depending on the value of a redundancy measure associated with a difference between the current video coding block and the predicted video coding block.

For instance, if the redundancy, which is sufficient for performing data hiding, is detected in prediction-related syntax elements, a prediction parameter to be coded at the same hierarchical level can be hidden within the prediction-related syntax elements. Otherwise, entropy coding can be used for signaling. A similar approach can be applied to data hiding in the residues: if the redundancy is detected there, data hiding can be used. Otherwise, entropy coding can be used for signaling at the TU level.

In an embodiment, signaling information on a lower hierarchical level can default to a value used at the higher lever, if signaling at the lower level is impossible (e.g., if the number of non-zero quantized transform coefficients is not enough to perform hiding in the residues) or forbidden (for example, entropy coded information can be disabled for small blocks such as 4×4 TUs to minimize a signaling overhead).

In an embodiment, the prediction parameter is a prediction flag defining a first state and a second state and the prediction unit 125 of the decoding apparatus 121 is configured to adjust the state of the prediction flag on the basis of the parameter adjustment information.

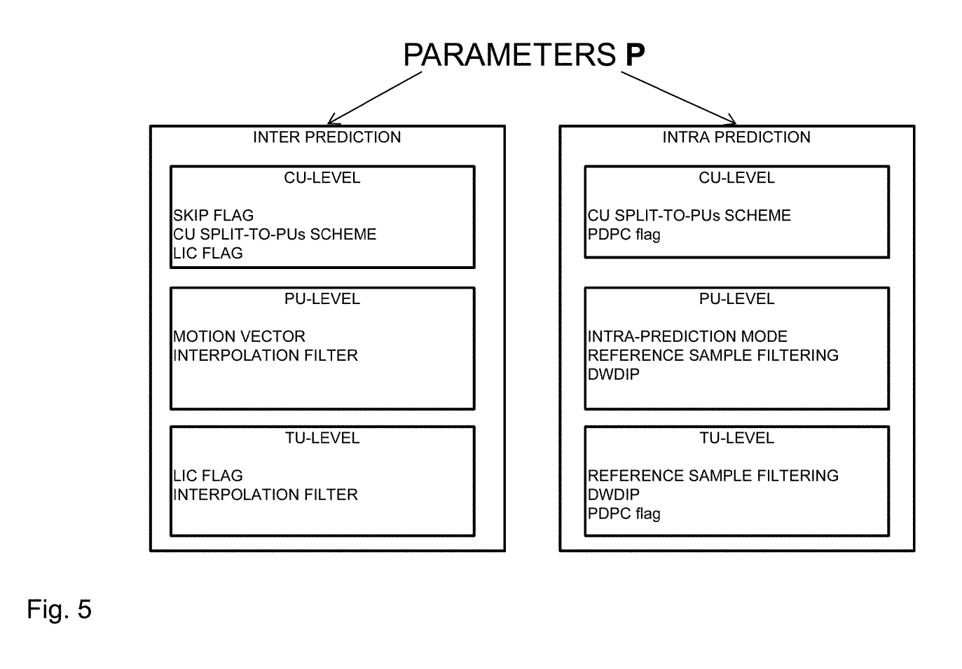

In an embodiment, the prediction parameter defines an intra-prediction mode, e.g. the prediction parameter is an intra-prediction mode index. More generally, the prediction parameter can comprises one or more of the parameters shown in FIG. 5, as will be described in more detail further below.

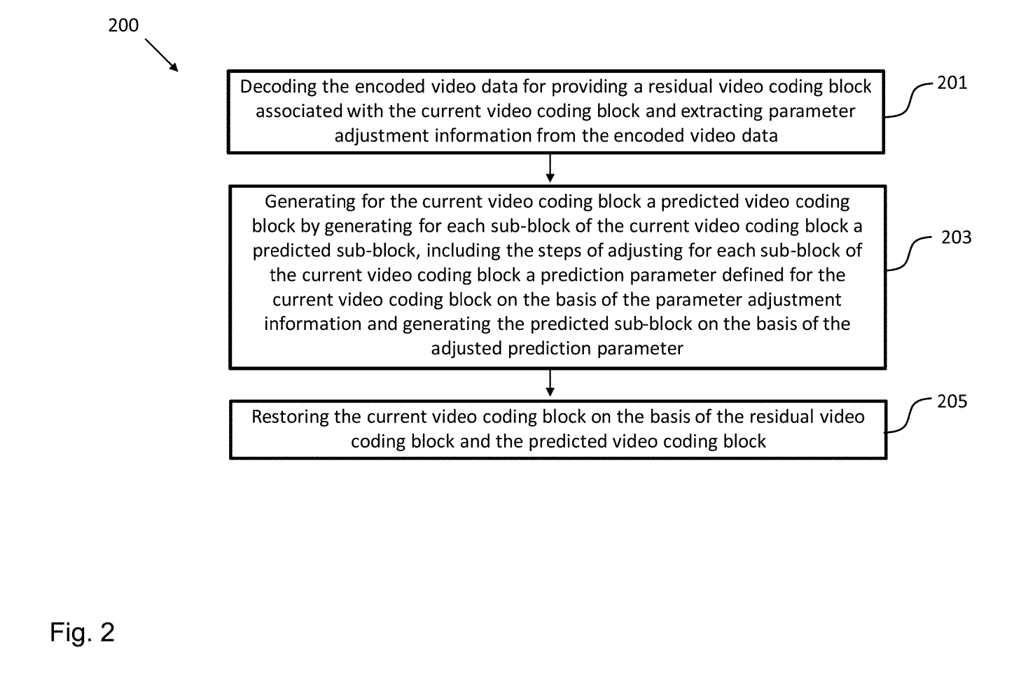

FIG. 2 shows a schematic diagram illustrating a corresponding method 200 for decoding encoded video data according to an embodiment, the encoded video data comprising a plurality of frames, each frame being partitioned into a plurality of video coding blocks, including a current, i.e. currently processed, video coding block, the current video coding block comprising a plurality of sub-blocks of a lower hierarchical level than the current video coding block.

The decoding method 200 comprises the following steps: decoding 201 the encoded video data for providing a residual video coding block associated with the current video coding block and extracting parameter adjustment information from the encoded video data; generating 203 for the current video coding block a predicted video coding block by generating for each sub-block of the current video coding block a predicted sub-block, including the steps of adjusting for each sub-block of the current video coding block a prediction parameter defined for the current video coding block on the basis of the parameter adjustment information and generating the predicted sub-block on the basis of the adjusted prediction parameter; and restoring 205 the current video coding block on the basis of the residual video coding block and the predicted video coding block.

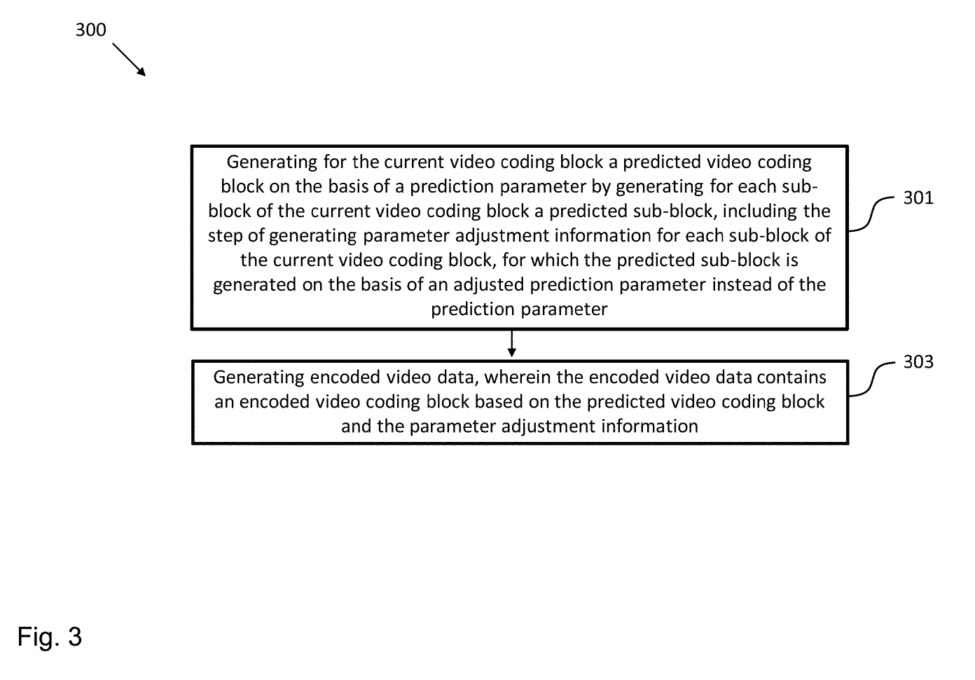

FIG. 3 shows a schematic diagram illustrating a method 300 for encoding video data according to an embodiment, the encoded video data comprising a plurality of frames, each frame being dividable into a plurality of video coding blocks, including a current, i.e. currently processed, video coding block, the current video coding block comprising a plurality of sub-blocks of a lower hierarchical level than the current video coding block.

The encoding method 300 comprises the steps of: generating 301 for the current video coding block a predicted video coding block on the basis of a prediction parameter by generating for each sub-block of the current video coding block a predicted sub-block, including the step of generating parameter adjustment information for each sub-block of the current video coding block, for which the predicted sub-block is generated on the basis of an adjusted prediction parameter instead of the prediction parameter; and generating 303 encoded video data, wherein the encoded video data contains an encoded video coding block based on the predicted video coding block and wherein the encoded video data contains the parameter adjustment information.

Further embodiments of the encoding apparatus 101, the decoding apparatus 121, the decoding method 200 and the encoding method 300 will be described in the following.

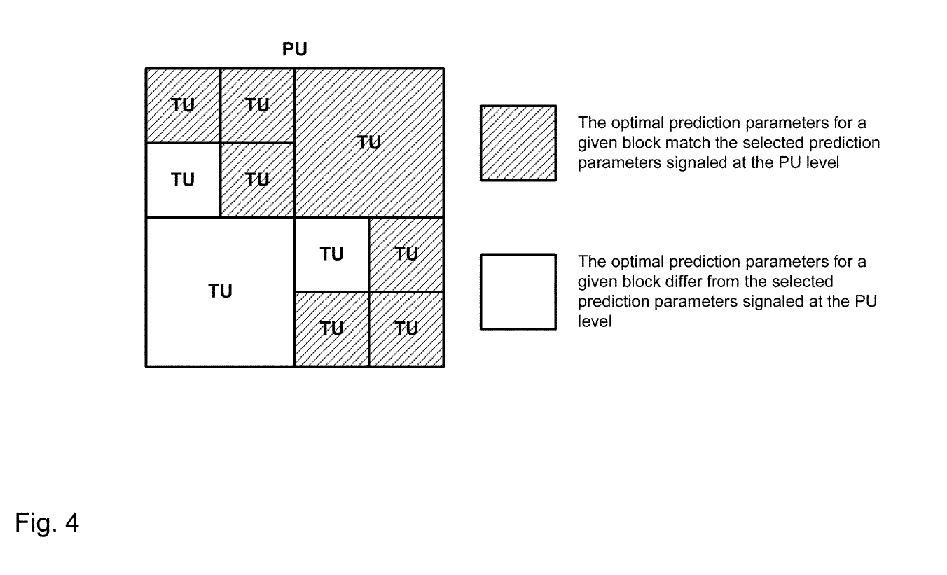

FIG. 4 shows a schematic diagram of an exemplary currently processed video coding block, wherein in this case the video coding block is a PU. The video coding block shown in FIG. 4 comprises a plurality of sub-blocks in the form of TUs. As can be taken from FIG. 4, these sub-blocks, i.e. TUs, can have different sizes, but are generally smaller than the current video coding block, i.e. the PU. Thus, the sub-blocks (i.e. the TUs) can be considered to be from a lower hierarchical level than the video coding block (i.e. the PU).

For a TU with a dashed background its optimal prediction parameter(s), as determined, for instance, on the basis of a rate distortion criterion, matches the prediction parameter(s) selected or defined for the PU, i.e. for the video coding block at a higher hierarchical level. For a TU with a white background its optimal prediction parameter(s), as determined, for instance, on the basis of a rate distortion criterion, differs from the prediction parameter(s) selected or defined for the PU, i.e. for the video coding block at the higher hierarchical level. Thus, for the exemplary sub-blocks of FIG. 4 having a white background the prediction unit 105 of the encoding apparatus 101 generates corresponding parameter adjustment information, which is included into the encoded video data by the encoding unit 103 of the encoding apparatus 101. On the side of the decoding apparatus 121 the decoding unit 123 extracts this parameter adjustment information from the encoded video data. On the basis thereof the prediction unit 125 adjusts for each of the exemplary sub-blocks of FIG. 4 having a white background the predictions parameter(s) signaled for the PU to one or more adjusted prediction parameters and generates the corresponding predicted sub-blocks on the basis of the one or more adjusted prediction parameters.

FIG. 5 shows a table of different (intra- and inter-) prediction parameters that can be used by and, if necessary, adjusted by the encoding apparatus 101 according to an embodiment and/or the decoding apparatus 121 according to an embodiment. For instance, the prediction parameter can define an intra prediction mode.

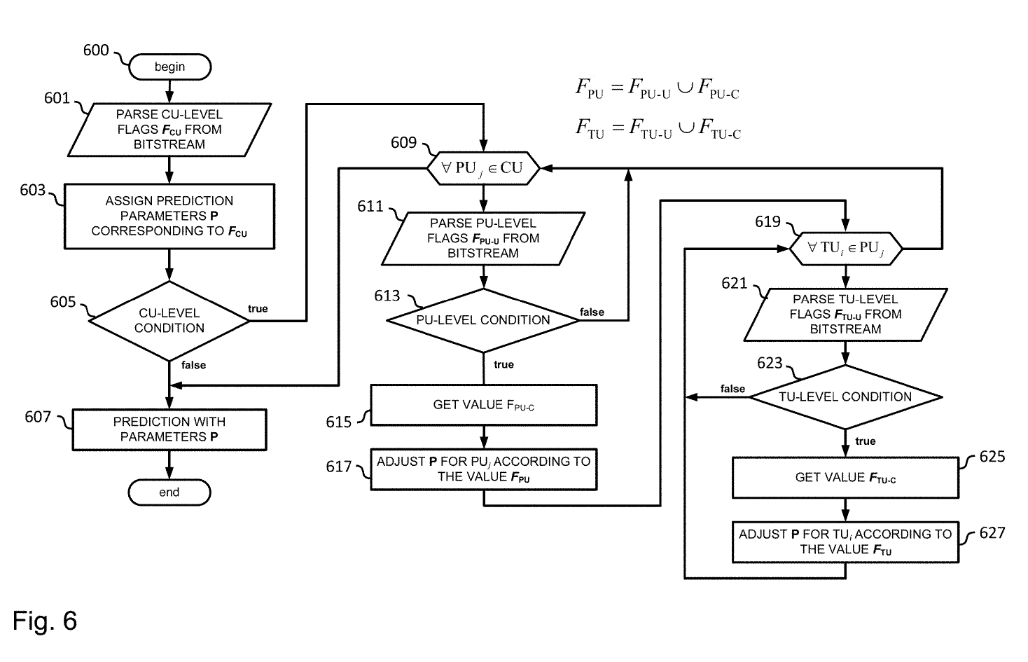

FIG. 6 shows a diagram illustrating processing steps of a processing scheme 600 implemented in the decoding apparatus 121 according to an embodiment. In the embodiment shown in FIG. 6 the decoding apparatus processes blocks at the CU-level, the PU-level and the TU-level. In this embodiment, a block at the CU-level is at a hierarchical higher level than its sub-blocks at the PU-level and the TU-level. Also a block at the PU-level is at a hierarchical higher level than its sub-blocks at the TU-level. The processing scheme 600 shown in FIG. 6 comprises the following processing steps.

A processing step 601 comprises parsing a set of CU-level flags F_{CU} from the bitstream provided by the encoding apparatus 101.

A processing step 603 comprises assigning values of prediction parameters P using values of F_{CU}.

A processing step 605 comprises checking CU-level conditions such as a skip flag. If these conditions are met, each PU should be processed by proceeding to processing step 609. Otherwise, the prediction parameters P can be applied to an entire CU “as-is” in processing step 607.

A processing step 611 comprises parsing a set of PU-level flags F_{PU-U} from the bitstream for each PU that belongs to the given CU. These flags F_{PU-U} (e.g., intra-prediction mode index or motion vector differences) can be unconditionally present in the bitstream.

A processing step 613 comprises checking PU-level conditions such as the flag that indicates which interpolation filter is to be selected for intra- or inter-prediction. If these conditions are met, some additional flags F_{PU-C} can be retrieved in processing step 615. Otherwise, processing of the next PU commences by returning to processing step 609.

A processing step 617 comprises adjusting the set of prediction parameters P using the set of flags F_{PU} and proceeding to each TU that belongs to a given PU (i.e. proceeding to processing step 619).

A processing step 621 comprises parsing a set of TU-level flags F_{PU-U} from the bitstream for each TU that belongs to the given PU. These flags F_{PU-U} (e.g., CBF) can be unconditionally present in the bit-stream.

A processing step 623 comprises checking TU-level conditions such as the number of non-zero quantized transform coefficients to detect whether a default transform is to be used or an EMT TU-level index is to be parsed. If these conditions are met, some additional flags F_{PU-C} can be retrieved in processing step 625. Otherwise, the next TU is processed by returning to processing step 619.

A processing step 627 comprises adjusting the set of prediction parameters P using the set of flags F_{TU} and processing the corresponding TU on the basis of the adjusted prediction parameters.

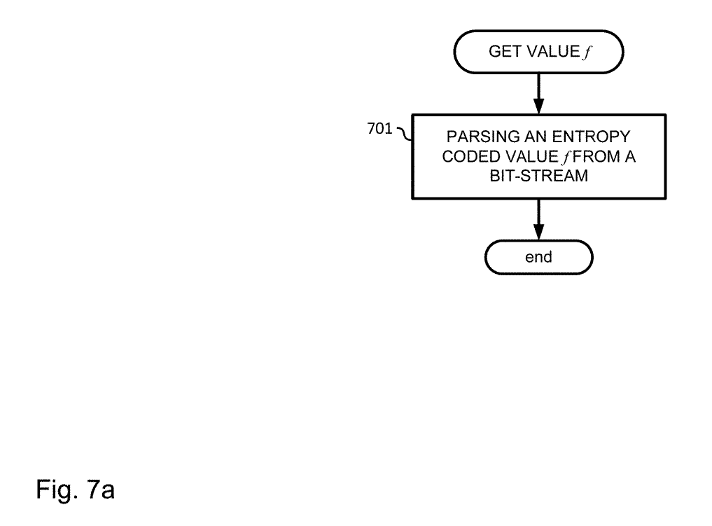

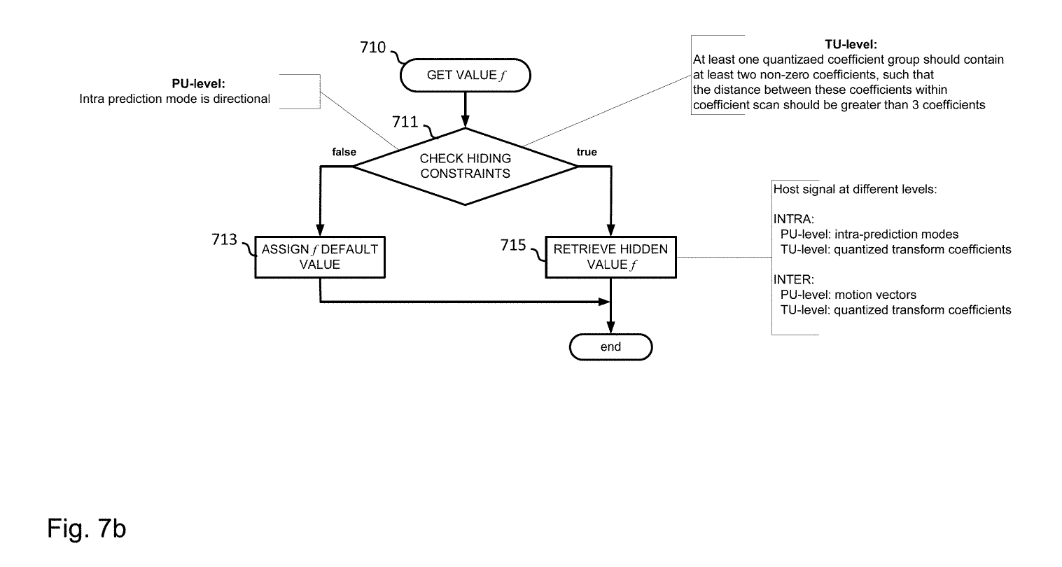

FIGS. 7a and 7b show diagrams illustrating processing steps implemented in the decoding apparatus 121 according to different embodiments for implementing the processing steps 615 and 625 shown in FIG. 6, namely the processing steps “GET VALUE F_{PU-C}” and “GET VALUE F_{TU-C}”. In an embodiment, these processing steps can differ depending on whether the parameter adjustment information is entropy coded or hidden in the encoded video data (e.g., intra-prediction mode index, motion vectors, and residues).

FIG. 7a shows processing steps implemented in an embodiment of the decoding apparatus 121 for the case of entropy coded values, i.e. entropy coded parameter adjustment information. In this embodiment, the parsing of an entropy coded value f, i.e. the entropy coded parameter adjustment information, can be performed from the bitstream provided by the encoding apparatus 101 (see processing step 701 of FIG. 7a).

FIG. 7b shows processing steps implemented in an embodiment of the decoding apparatus 121 for the case the parameter adjustment information, i.e. the value f, is hidden in the host signal. In a processing step 711, some hiding constraints (e.g., whether the number of non-zero quantized transform coefficients is larger than a threshold value or not) can be checked. If they are fulfilled, the parameter adjustment information, i.e. the hidden value f, is retrieved by applying a check function (e.g., parity check function) to the host signal in processing step 715. Otherwise, a default value is assigned to the parameter adjustment information in processing step 713.

It should be noted that according to embodiments of the disclosure at each hierarchical level, relevant syntax elements of the video data to be encoded can be selected as host signals (e.g., at the PU-level, intra-prediction mode index or motion vectors as well as, at the TU-level, residues, i.e. non-zero quantized transform coefficients). A plurality of different data hiding techniques can be implemented in the encoding apparatus 101 (as well as the decoding apparatus 121) for hiding the parameter adjustment information in the encoded video data and, thereby, reduce any signal overhead caused by the inclusion of the parameter adjustment information in the encoded video data. More details about data hiding techniques, which can be implemented in embodiments of the disclosure for hiding the parameter adjustment information in the encoded video data, can be found, for instance, Vivienne Sze, Madhukar Budagavi, Gary J. Sullivan, “High Efficiency Video Coding (HEVC): Algorithms and Architectures,” Springer, 2014, ISBN 978-3-319-06895-4, which is fully incorporated herein by reference.

In the following further embodiments of the encoding apparatus 101 and the decoding apparatus 121 will be described in the context of three different intra-prediction schemes, namely PDPC (Position Dependent Intra Prediction Combination), ARSS/RSAF (Adaptive Reference Sample Smoothing/Reference Sample Adaptive Filter) and DWDIP (Distance-Weighted Directional Intra-Prediction). While PDPC, which refers to a technique that generates an intra-predictor using the values of reference samples before and after smoothing them, and ARSS/RSAF, which refers to a technique that enables or disables reference sample smoothing using the value of a special hidden flag, are known from the prior art, DWDIP will be briefly described in the following.

Generally, DWDIP involves intra-predicting a pixel value of a pixel of a currently processed video coding block (or a sub-block thereof) by a distance weighted linear combination of two reference pixels values. For more details concerning DWIDP, reference may be made to two further patent applications by the inventors of the present application, which have been filed on the same day as the present application.

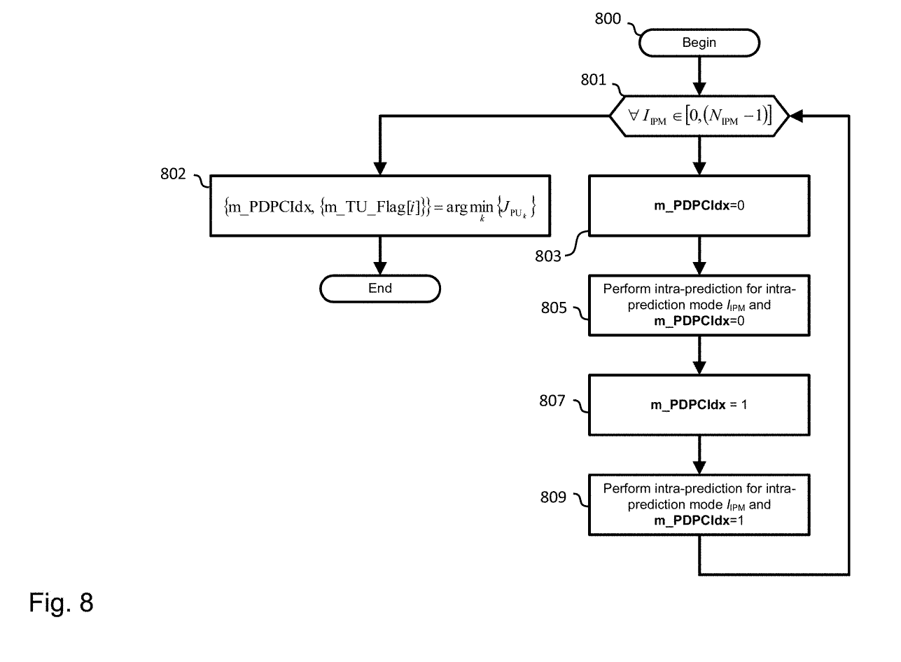

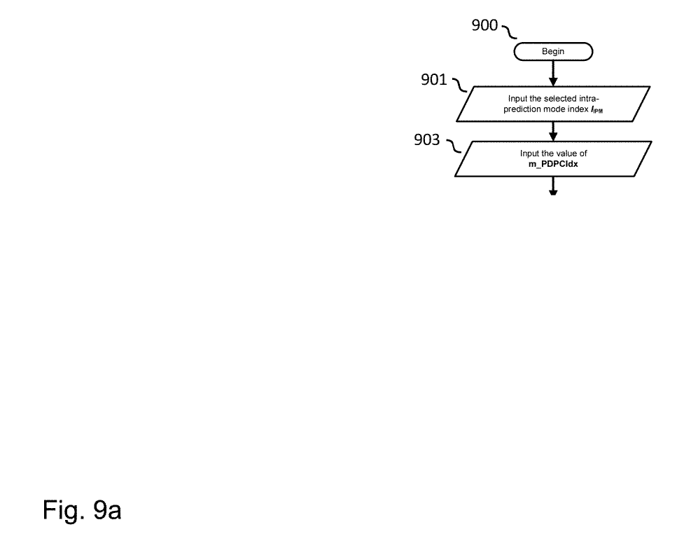

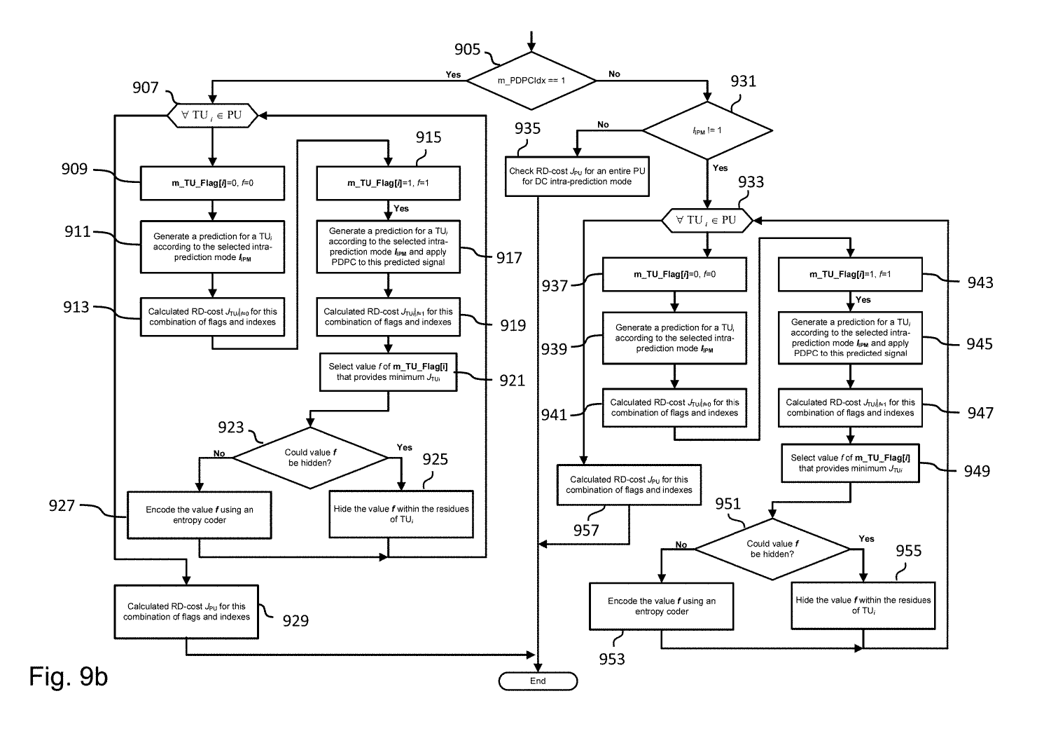

FIG. 8 shows an intra-prediction processing scheme 800 implemented in the encoding apparatus 101 according to an embodiment, where both PDPC and ARSS/RSAF are used as intra-prediction tools. More specifically, the rate distortion costs are computed for different combinations of intra-prediction tool flags and indices (see processing steps 801, 803, 805, 807 and 809) and that combination of PU- and TU-level flags and indices is selected that provides the minimal rate distortion cost (see processing step 802). The intra-prediction process is based on PDPC or ARSS/RSAF. The details of this intra-prediction process (hidden in processing steps 805 and 809) are provided by the processing scheme 900 shown in FIGS. 9a and 9b.

FIGS. 9a and 9b show diagrams illustrating a processing scheme 900 implemented in the encoding apparatus 101 according to an embodiment. For the selected values of the intra-prediction mode index I_{IPM} and the PDPC flag m_PDPCIdx (see processing steps 901 and 903), an intra-predictor, i.e. a predicted block, is generated taking into account the option that the TU-level flag m_TU_Flag can be assigned either to 0 (right hand side of the processing scheme 900 shown in FIG. 9b) or to 1 (left hand side of the processing scheme 900 shown in FIG. 9b) to provide a better predictor in terms of a rate distortion cost. This TU-level flag m_TU_Flag can have different meanings subject to what value m_PDPCIdx takes. If m_PDPCIdx==1, then for non-DC intra prediction modes (the check is performed in processing step 931) the m_TU_Flag switches on (m_TU_Flag==1) or off (m_TU_Flag==0) the PDPC mechanism for a TU. If m_PDPCIdx==0, then m_TU_Flag switches on (m_TU_Flag==1) or off (m_TU_Flag==0) the ARSS/RSAF mechanism for a TU. In both cases, it is possible to achieve additional coding gain due to a more flexible prediction mechanism that can provide a more precise predictor that allows to exceed the RD-cost increase caused by the addition signaling overhead because of putting the TU-level flag m_TU_Flag, i.e. the parameter adjustment information, into the encoded bitstream.

More specifically, by means of the processing scheme 900 the encoding apparatus iterates over TUs belonging to a PU (processing steps 907 and 933), generates a prediction signal for each TU (processing steps 911, 917, 939, 945) for the parameters that are adaptively assigned in the corresponding processing steps of calculating the RD cost for each of the predicted signals (processing steps 913, 919, 941, 947) and selects the best (i.e. optimal) variant depending on the calculated RD cost (processing steps 921, 949). Each of the best variants has a set of flags defined in one of the processing steps (processing steps 909, 915, 937 or 943). After the encoding apparatus 101 has selected the best combination of flags, the RD cost is calculated for the whole PU (processing steps 929, 935) that is used for the further PU-level RD-optimization process.

As already described above, the TU-level flag m_TU_Flag can be either entropy-coded or hidden, for example, in TU residues (see processing steps 923, 925, 927 and processing steps 951, 953, 955). In the latter case, this flag can be hidden if some hiding conditions are met (e.g., the number of non-zero quantized transform coefficients or the distance between the last and the first non-zero quantized transform coefficients are more than a threshold value). Otherwise, m_TU_Flag is set to its default value, i.e. 0 (m_TU_Flag==0).

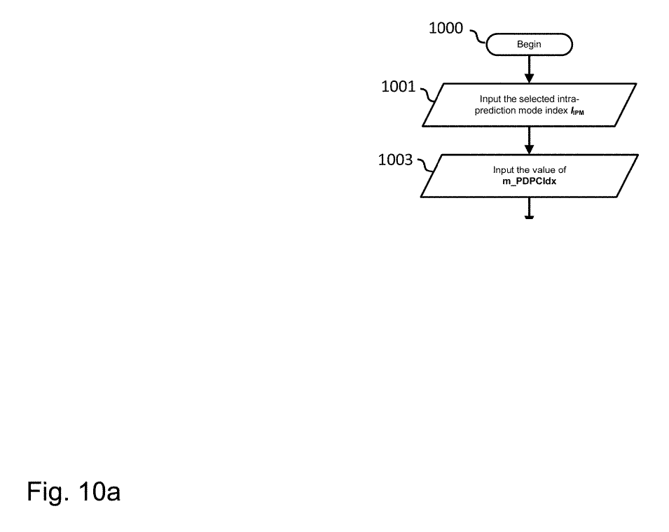

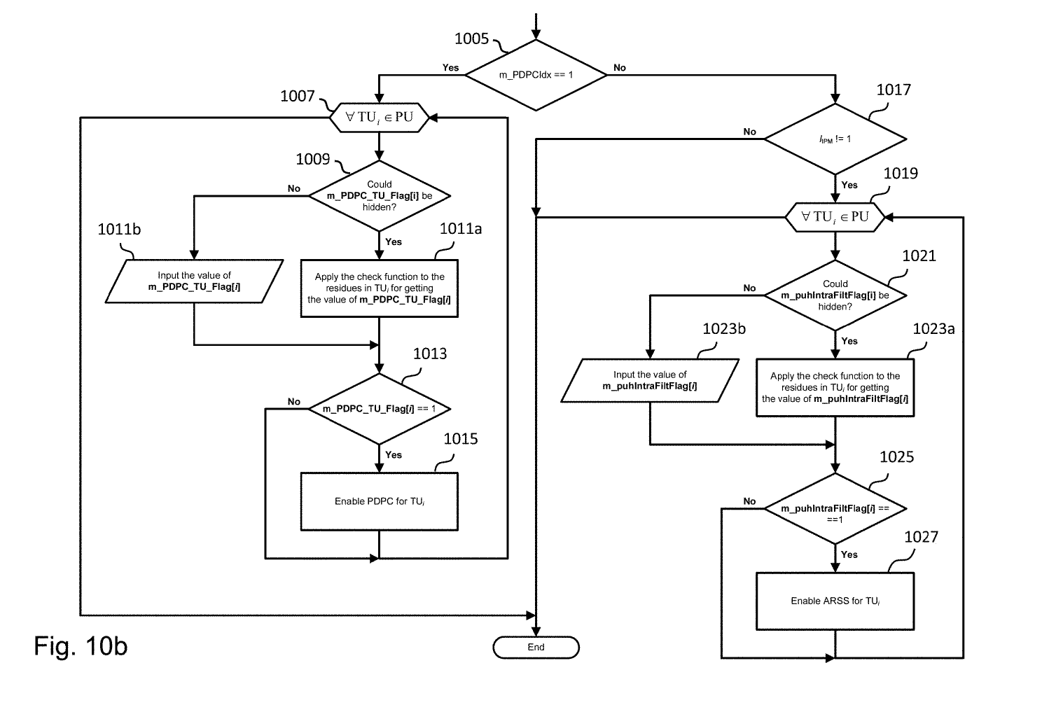

FIGS. 10a and 10b show diagrams illustrating a corresponding processing scheme 1000 implemented in the decoding apparatus 121 according to an embodiment, where both PDPC and ARSS/RSAF are used as intra-prediction tools.

After parsing values of the intra-prediction mode index I_{IPM} and the PDPC flag m_PDPCIdx (see processing steps 1001 and 1003), the value of m_PDPCIdx is checked (see processing step 1005). If m_PDPCIIdx==1, then for each TU that belongs to a given PU it is checked whether to apply the PDPC mechanism to the TU or not (see processing loop consisting of the processing steps 1007, 1009, 1011a, 1011b, 1013, 1015). Otherwise, the ARSS/RSAF mechanism replaces PDPC (see processing loop consisting of the processing steps 1019, 1021, 1023a, 1023b, 1025, 1027), if the planar or directional intra-prediction mode (I_{IPM}!=1) is selected (see processing step 1017). If the DC intra-prediction mode is selected, adaptive reference sample smoothing (ARSS/RSAF) can be skipped (see processing step 1025). Moreover, for each TU that belongs to a given PU, it is to be checked whether the hiding conditions (“Could m_TU_Flag[i] be hidden?”) are fulfilled or not (see processing steps 1009 and 1021). If they are met, the check function is applied to the residues in a given TU to retrieve the value of m_TU_Flag (see processing steps 1011a, 1023a) If not, the bit-stream can be parsed to obtain the value of m_TU_Flag (see processing steps 1011b, 1023b). If m_TU_Flag[i]==0, neither PDPC nor ARSS/RSAF are applied to the ith TU (see processing steps 1013 and 1025). Otherwise, PDPC and ARSS/RSAF are used for m_PDPCIdx==1 and m_PDPCIdx==0, respectively (see processing steps 1015 and 1027).

In the following further embodiments of the encoding apparatus 101 and the decoding apparatus 121 will be described, which also make use of the DWDIP technique already mentioned above.

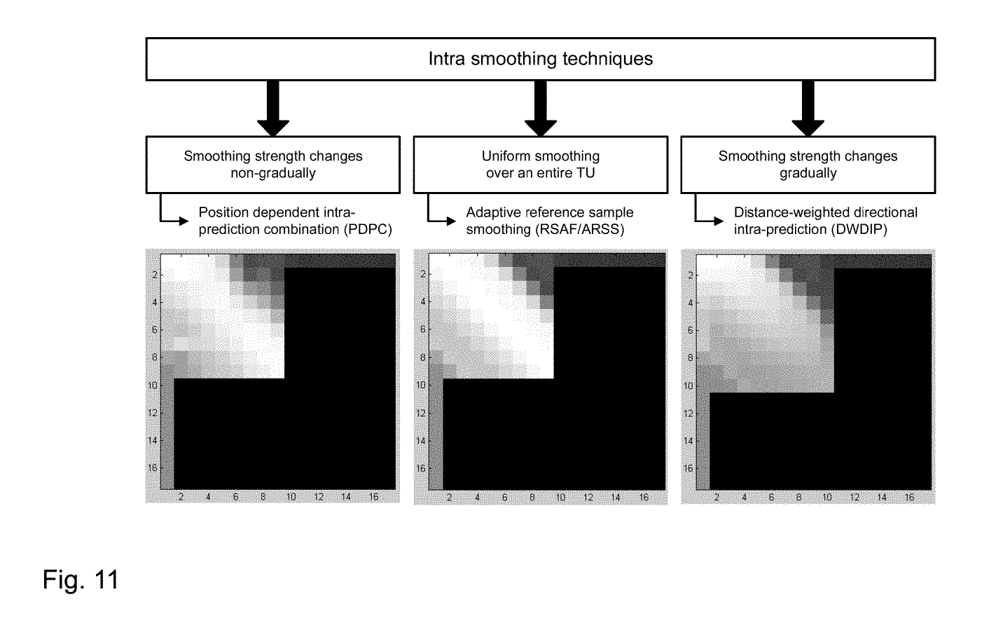

FIG. 11 shows three different video coding blocks predicted by embodiments of the present disclosure using the PDPC technique, the ARSS/RSAF technique and the DWDIP technique.

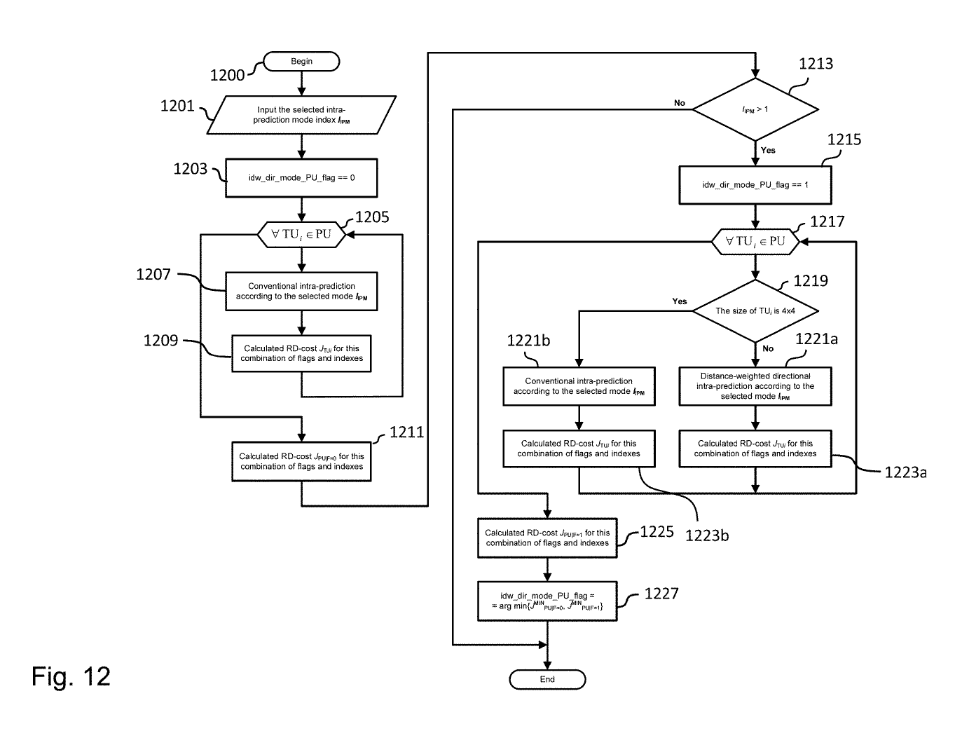

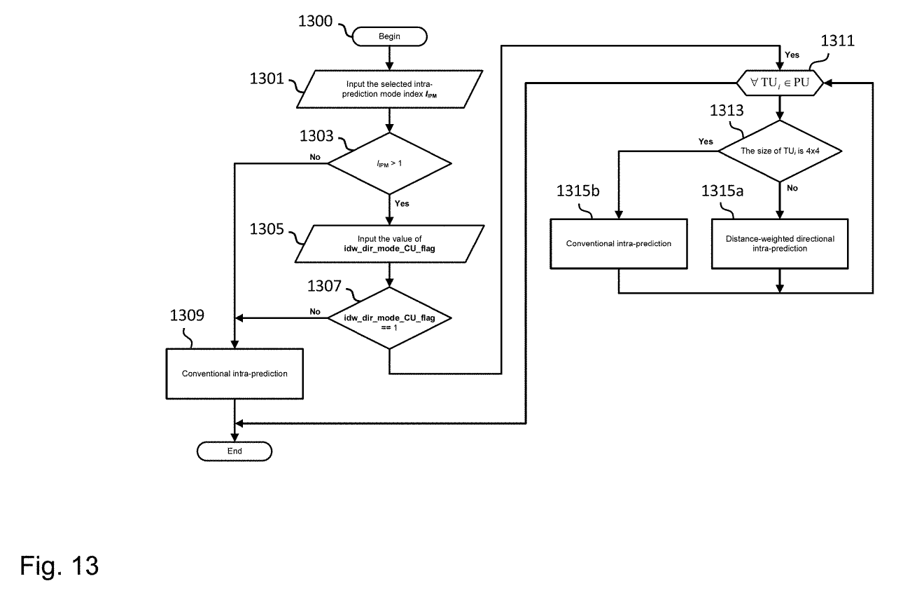

FIG. 12 shows a diagram illustrating a processing scheme implemented in the encoding apparatus 101 according to an embodiment, which makes use of the DWDIP technique. FIG. 13 shows a diagram illustrating a corresponding processing scheme implemented in the decoding apparatus 121 according to an embodiment.

At the PU-level, the encoding apparatus 101 checks two cases when the DWDIP processing is enabled (idw_dir_mode_PU_flag==1; see processing step 1215) for the intra prediction mode (determined in processing step 1201) or not (idw_dir_mode_PU_flag==0; see processing step 1203). For both cases, the RD cost is calculated (see processing steps 1211, 1225) for different variants of RQT (Residual Quad-Tree; partitioning on the TU level) if DWDIP is on and off (see processing steps 1205, 1217). It is worth to note that by definition, DWDIP is only applicable to directional intra-prediction modes, i.e. I_{IPM}>1 (see processing step 1213). Finally, such a value of the flag idw_dir_mode_PU_flag is selected that provides the minimal RD-cost (see processing step 1227). Processing step 1211 of calculating the PU-level RD cost may use the results of the TU-level RD cost calculation (processing step 1209). Analogously, processing step 1225 may use the results of processing steps 1223a and 1223b. For 4×4 TUs, DWDIP can be disabled for any value of the flag idw_dir_mode_PU_flag (see processing steps 1219, 1221b and 1221a).

The corresponding scheme 1300 shown in FIG. 13, which is implemented in the decoding apparatus 121 according to an embodiment, uses the same constraints and syntax elements to be parsed and, therefore, the processing steps of the processing scheme 1300 shown in FIG. 13 are equivalent to the processing steps of the processing scheme 1200, which has been described above.

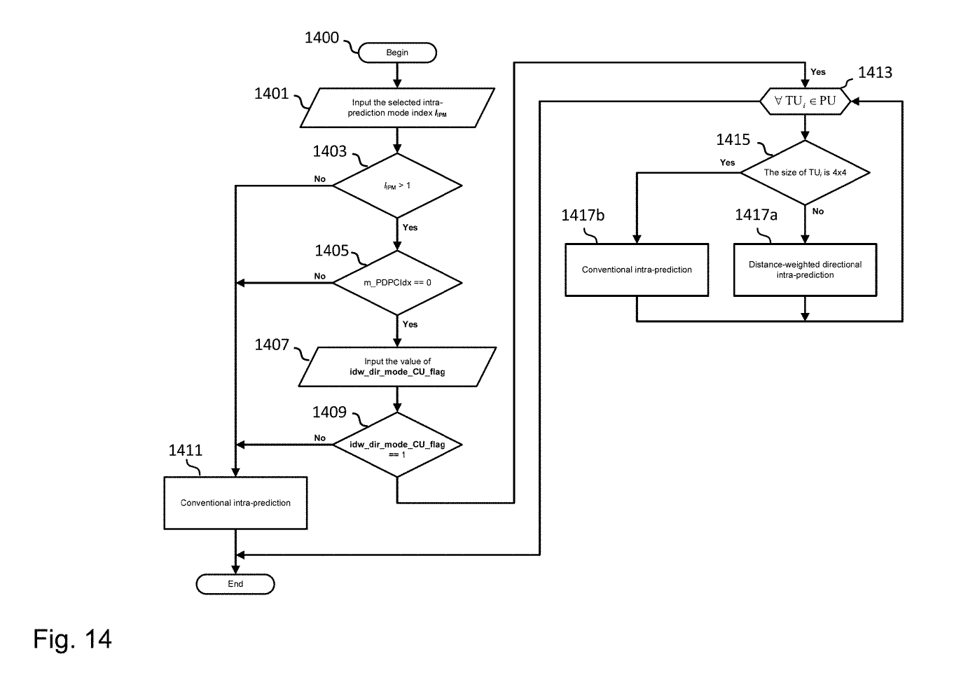

FIG. 14 shows a diagram illustrating a processing scheme 1400 implemented in the decoding apparatus 121 according to an embodiment, which makes use of the PDPC technique as well as the DWDIP technique. The processing scheme 1400 shown in FIG. 14 differs from the processing scheme 1300 shown in FIG. 13 only in including the PDPC technique that can be either on or off by using m_PDPCIdx (see processing step 1405). As the other processing steps of the processing scheme 1400 shown in FIG. 14 are identical to the corresponding processing steps of the processing scheme 1300 shown in FIG. 13, reference is made to the description above of the processing steps of the processing schemes 1200 and 1300 shown in FIGS. 12 and 13.

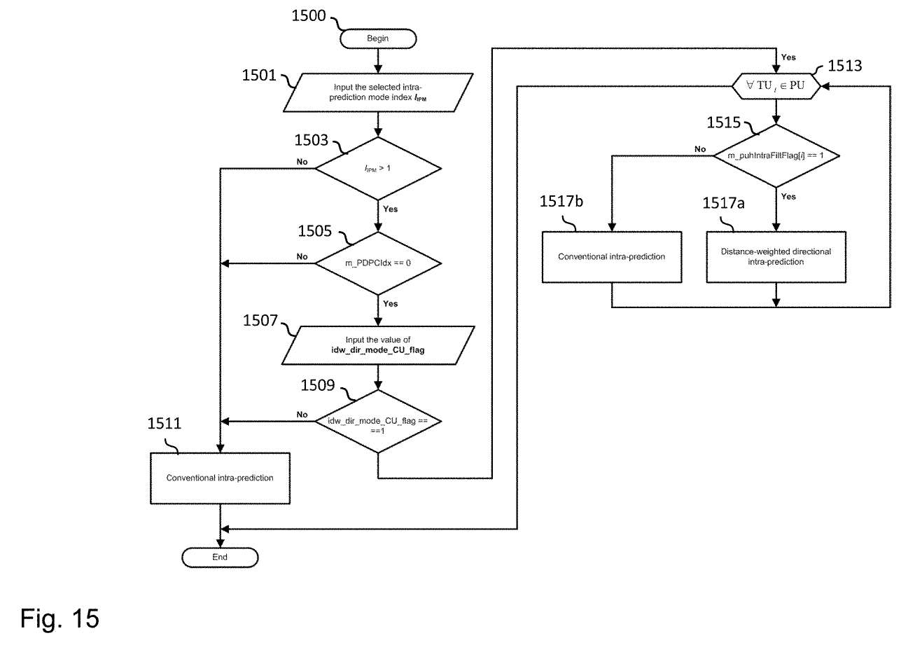

FIG. 15 shows a diagram illustrating a processing scheme 1500 implemented in the decoding apparatus 121 according to an embodiment, which makes use of the PDPC technique as well as the DWDIP technique and allows disabling the DWDIP technique at the TU level. The processing scheme 1500 shown in FIG. 15 differs from the processing scheme 1400 shown in FIG. 14 only in adding the flag m_puhIntraFiltFlag that allows enabling (m_puhIntraFiltFlag[i]==1) and disabling (m_puhIntraFiltFlag[l]==0) the DWDIP processing at the TU level (see processing step 1515). As the other processing steps of the processing scheme 1500 shown in FIG. 15 are identical to the corresponding processing steps of the processing schemes 1300, 1400 shown in FIGS. 13 and 14, reference is made to the description above of the processing steps of the processing schemes 1200 and 1300 shown in FIGS. 12 and 13.

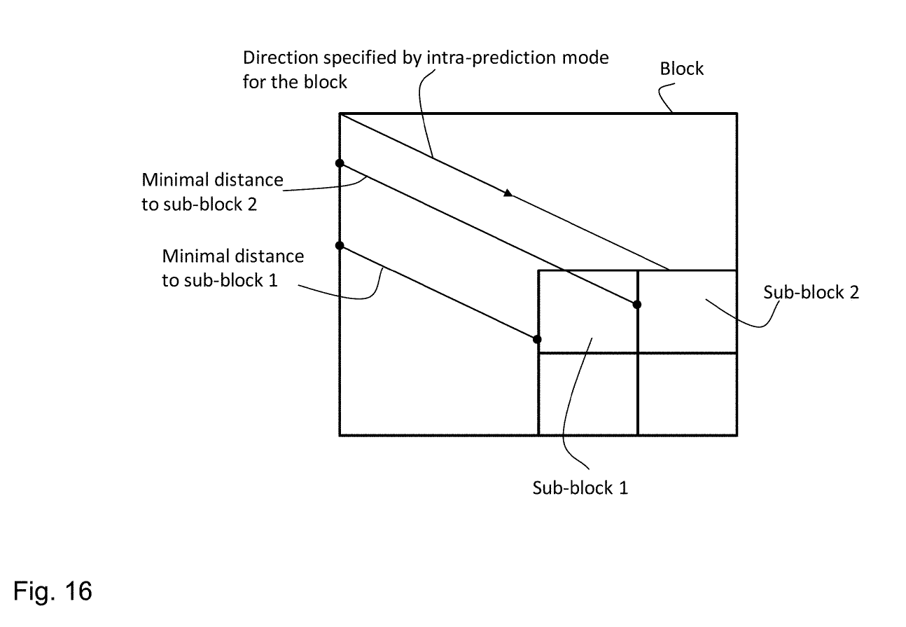

FIG. 16 shows a schematic diagram of an exemplary video coding block illustrating aspects implemented in embodiments of the disclosure. As illustrated in FIG. 16, parameter adjustment information used by the encoding apparatus 101 and/or the decoding apparatus 121 according to an embodiment can also comprise information about the position of a sub-block within the currently processed video coding block. In case of an angular intra-prediction specific positions can be determined by the minimal distance from a sub-block to the reference samples of a currently processed video coding block, e.g. the already predicted reference samples of a neighboring video coding block. This minimal distance can be calculated in the direction specified by the angular intra-prediction mode and compared to a pre-defined threshold that depends on the size of a block. The decision on whether to perform an adjustment of the prediction parameter(s) for the sub-block can be taken depending on the result of the comparison with the pre-defined threshold.

Embodiments of the disclosure allow adjusting a predictor or prediction block by exploiting the hierarchical structure to signal different decisions on a selected predictor at different levels. According to embodiments of the disclosure the decisions made on lower levels can override the decisions made for higher levels. However, according to embodiments of the disclosure signaling information on lower hierarchical levels can default to a value used at the higher lever, if signaling at the lower level is impossible (e.g., if the number of non-zero quantized transform coefficients is not enough to perform hiding in residues) or forbidden (for example, entropy coded information can be disabled for small blocks such as 4×4 TUs to minimize a signaling overhead).

Different techniques of representing a coded prediction parameter on different hierarchical levels can be implemented in embodiments of the disclosure, which allow minimizing a signaling overhead by flexibly selecting between entropy coding or data hiding subject to the redundancy contained in both prediction-related syntax elements (such intra-prediction mode indexes or motion vector differences) and residues. If the redundancy, which is sufficient for performing data hiding, is detected in the prediction-related syntax elements, a prediction parameter to be coded at the same hierarchical level can be hidden within them. Otherwise, entropy coding can be used for signaling. A similar approach can be applied to data hiding in the residues: if the redundancy is detected there, data hiding can be used. Otherwise, entropy coding can be used for signaling at the TU level.

While a particular feature or aspect of the disclosure may have been disclosed with respect to only one of several implementations or embodiments, such a feature or aspect may be combined with one or more further features or aspects of the other implementations or embodiments as may be desired or advantageous for any given or particular application. Furthermore, to the extent that the terms “include”, “have”, “with”, or other variants thereof are used in either the detailed description or the claims, such terms are intended to be inclusive in a manner similar to the term “comprise”. Also, the terms “exemplary”, “for example” and “e.g.” are merely meant as an example, rather than the best or optimal. The terms “coupled” and “connected”, along with derivatives thereof may have been used. It should be understood that these terms may have been used to indicate that two elements cooperate or interact with each other regardless whether they are in direct physical or electrical contact, or they are not in direct contact with each other.

Although specific aspects have been illustrated and described herein, it will be appreciated that a variety of alternate and/or equivalent implementations may be substituted for the specific aspects shown and described without departing from the scope of the present disclosure. This application is intended to cover any adaptations or variations of the specific aspects discussed herein.

Although the elements in the following claims are recited in a particular sequence with corresponding labeling, unless the claim recitations otherwise imply a particular sequence for implementing some or all of those elements, those elements are not necessarily intended to be limited to being implemented in that particular sequence.

Many alternatives, modifications, and variations will be apparent to those skilled in the art in light of the above teachings. Of course, those skilled in the art readily recognize that there are numerous applications of the disclosure beyond those described herein. While the present disclosure makes reference to one or more particular embodiments, those skilled in the art recognize that many changes may be made thereto without departing from the scope of the present disclosure. It is therefore to be understood that within the scope of the appended claims and their equivalents, the disclosure may be practiced otherwise than as specifically described herein.

What is claimed is:

1. An apparatus for decoding encoded video data, the encoded video data comprising a plurality of frames, each frame being partitioned into a plurality of video coding blocks, including a current video coding block, the current video coding block comprising a plurality of sub-blocks, wherein the apparatus comprises processing circuitry configured to:
decode the encoded video data for providing a residual video coding block associated with the current video coding block and to extract parameter adjustment information from the encoded video data;
generate for the current video coding block a predicted video coding block by generating for each sub-block of the current video coding block a predicted sub-block, and adjust for each sub-block of the current video coding block a prediction parameter defined for the current video coding block on the basis of the parameter adjustment information and generate the predicted sub-block on the basis of the adjusted prediction parameter; and
restore the current video coding block on the basis of the residual video coding block and the predicted video coding block.

2. The decoding apparatus of claim 1, wherein the processing circuitry is configured to perform an intra prediction or an inter prediction, or both an intra prediction and an inter prediction, for generating the predicted video coding block.

3. The decoding apparatus of claim 1, wherein the encoded video data is entropy encoded and wherein the processing circuitry is configured to extract the parameter adjustment information from the encoded video data by decoding the encoded video data.

4. The decoding apparatus of claim 1, wherein the parameter adjustment information is hidden in the encoded video data on the basis of a data hiding technique and wherein the processing circuitry is configured to extract the parameter adjustment information from the encoded video data by applying a check function, in particular a parity check function, to the encoded video data.

5. The decoding apparatus of claim 1, wherein the prediction parameter is a prediction flag defining a first state and a second state and wherein the processing circuitry is configured to adjust the state of the prediction flag on the basis of the parameter adjustment information.

6. The decoding apparatus of claim 5, wherein the prediction parameter defines an intra-prediction mode.

7. A method for decoding encoded video data, the encoded video data comprising a plurality of frames, each frame being partitioned into a plurality of video coding blocks, including a current video coding block, the current video coding block comprising a plurality of sub-blocks, wherein the decoding method comprises:
decoding the encoded video data for providing a residual video coding block associated with the current video coding block and extracting parameter adjustment information from the encoded video data;
generating for the current video coding block a predicted video coding block by generating for each sub-block of the current video coding block a predicted sub-block, including the steps of adjusting for each sub-block of the current video coding block a prediction parameter defined for the current video coding block on the basis of the parameter adjustment information and generating the predicted sub-block on the basis of the adjusted prediction parameter; and
restoring the current video coding block on the basis of the residual video coding block and the predicted video coding block.

8. An apparatus for encoding video data, the encoded video data comprising a plurality of frames, each frame being dividable into a plurality of video coding blocks, including a current video coding block, the current video coding block comprising a plurality of sub-blocks, wherein the apparatus comprises processing circuitry configured to:
generate for the current video coding block a predicted video coding block on the basis of a prediction parameter by generating for each sub-block of the current video coding block a predicted sub-block, and generate parameter adjustment information for each sub-block of the current video coding block for which the predicted sub-block is generated on the basis of an adjusted prediction parameter; and
generate encoded video data, wherein the encoded video data contains an encoded video coding block based on the predicted video coding block and wherein the encoded video data contains the parameter adjustment information.

9. The encoding apparatus of claim 8, wherein the processing circuitry is configured to perform an intra prediction and/or an inter prediction for generating the predicted video coding block on the basis of the current video coding block.

10. The encoding apparatus of claim 8, wherein the processing circuitry is further configured to decide for each sub-block of the current video coding block on the basis of a rate distortion criterion whether to generate the predicted sub-block on the basis of an adjusted prediction parameter.

11. The encoding apparatus of claim 8, wherein the processing circuitry is configured to include the parameter adjustment information as entropy encoded parameter adjustment information in the encoded video data.

12. The encoding apparatus of claim 8, wherein the processing circuitry is configured to include the parameter adjustment information in the encoded video data on the basis of a data hiding technique.

13. The encoding apparatus of claim 8, wherein the processing circuitry is configured to include the parameter adjustment information in the encoded video data on the basis of a data hiding technique or to include the parameter adjustment information as entropy encoded parameter adjustment information in the encoded video data depending on the value of a redundancy measure associated with a difference between the current video coding block and the predicted video coding block.

14. A method for encoding video data, the encoded video data comprising a plurality of frames, each frame being dividable into a plurality of video coding blocks, including a current video coding block, the current video coding block comprising a plurality of sub-blocks, wherein the method comprises:
generating for the current video coding block a predicted video coding block on the basis of a prediction parameter by generating for each sub-block of the current video coding block a predicted sub-block, including a step of generating parameter adjustment information for each sub-block of the current video coding block, for which the predicted sub-block is generated on the basis of an adjusted prediction parameter; and
generating encoded video data, wherein the encoded video data contains an encoded video coding block based on the predicted video coding block and wherein the encoded video data contains the parameter adjustment information.

15. A non-transitory computer-readable medium comprising program code which, when executed on a computer, causes the computer to perform the method of claim 7.
